(19) United States
(12) Patent Application Publication
(10) Pub. No.: US 2005/0252412 A1
(43) Pub. Date: Nov. 17, 2005

(54) Disazo dyes having adapted affinity

(76) Inventor: Markus Gisler, Rheinfelden (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/518,004

(22) PCT Filed: Jun. 11, 2003
(86) PCT No.: PCT/IB03/02396

§ 371 Date: Dec. 13, 2004

(30) Foreign Application Priority Data
Jun. 13, 2002 (CH) 2002 1012/02

(51) Int. Cl. C09D 11/02; C09D 11/00

(52) U.S. Cl. 106/31.52; 106/31.81

(57) ABSTRACT

Mixtures containing compounds of formula 1 (formula see on enclosed paper version) or mixtures of compounds of formula 1 where R1 is II. SO3II. R2 is II. SO3IIZ1 is CII═CII2. CII2CII2SO3IIZ2 is CII═CII2. CII2CII2SO3II.

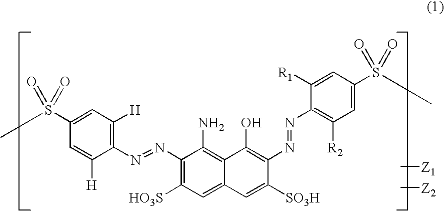

This invention relates to reactive dye mixtures, their preparation and use for dyeing or printing fibre materials, including in particular by ink jet processes. The invention further relates to dye mixtures for the trichromatic dyeing process containing the novel reactive dye mixtures and processes for their use.

Trichromatic dyeing is well known from the literature for different classes of dye, for example from EP 83 299, DE 2623178, EP 226 982 and EP 808 940.

The dyeing and printing of cotton and cellulosic materials requires dyes or dye mixtures which have an adapted affinity and which also provide good wash-off with regard to unfixed portions. They shall further possess a high reactivity, so that only brief dwell times are needed, and they shall provide in particular dyeings having high degrees of fixation.

The novel dyes should be notable in particular for high fixation yields and high fibre-dye bond stabilities and, moreover, portions not fixed to the fibre should be easy to wash off.

They should further provide dyeings having good all-round fastnesses, for example light and wet fastness.

The dyes to be used in the process shall exhibit a uniform colour build-up in a constant hue at various concentrations.

Reactive dyes having two (or more) sulphatoethyl sulphone reactive groups that, in an exhaust process, have little affinity for fibre before alkali is added but will suddenly go onto the fibre after alkali has been added may lead to sketchy or unlevel dyeings in the exhaust process. Such dyes are difficult to combine in trichromatic dyeings with further trichromatic partners of medium and high affinity.

The present invention therefore had for its object to find novel, improved reactive dyes or reactive dye mixtures which possess the above-characterized qualities to a high degree.

It has been determined that the mixtures according to the invention, of defined novel bireactive dye mixtures, achieve the stated object.

The invention accordingly provides mixtures containing compounds of formula 1 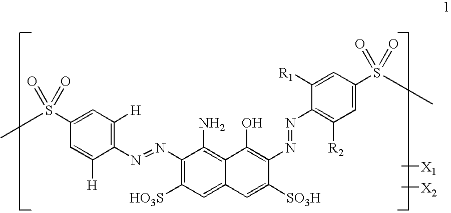
or mixtures of compound of formula 1
where
R₁ is H, SO₃H,
R₂ is H, SO₃H
X₁ is CH═CH₂, CH₂CH₂OSO₃H
X₂ is CH═CH₂, CH₂CH₂OSO₃H,
characterized in that the fraction of the compound 1d 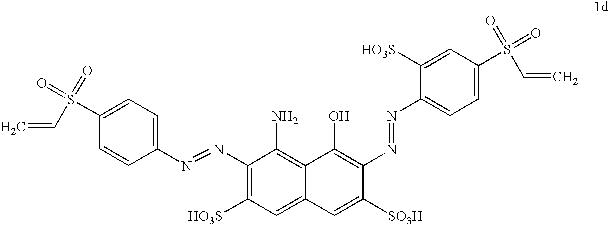
   in the mixtures per formula 1 is more than 40%.

Dye 1 according to the invention and mixtures of such dyes are suitable as a blue component for the trichromatic dyeing process. The dye 1d according to the invention is particularly suitable as blue components for the trichromatic dyeing process.

Preferred mixtures containing mixtures of compounds as per formula 1 the mixture of the compounds as per formula 1 comprises more than 50% of the compound as per formula 1d 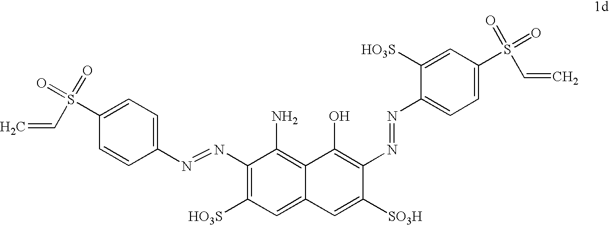
and less than 20% of the compound as per formula 2 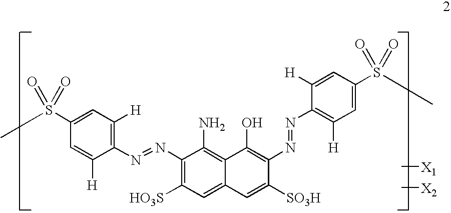
and less than 10% of the compound as per formula 3 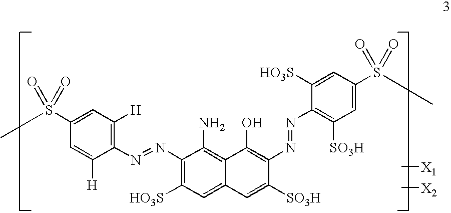
where
R₁ is H, SO₃H,
R₂ is H, SO₃H
X₁ is CH═CH₂, CH₂CH₂OSO₃H
X₂ is CH═CH₂, CH₂CH₂OSO₃H.

Dye mixes suitable for dyeing by the trichromatic process contain dyes as per the formula 1 as blue elements together with at least one red or reddish brown dyeing component and at least one yellow or orange dyeing component.

The inventive compounds and mixtures of compounds are suitable for dyeing or printing hydroxyl- or nitrogen-containing organic substrates.

As per another aspect of the invention there is accordingly provided a process for dyeing or printing hydroxyl- or nitrogen-containing organic substrates when dyeing or printing is carried out with the above-defined compounds or mixtures.

It should be noted that any reference to compounds or mixtures in the plural shall also be construed as a reference to a compound or a mixture in the singular, and vice versa. Any reference to printing techniques always comprehends as well as the classic processes the more recent printing processes such as for example the ink jet printing process.

Preferred substrates are leather and fibre materials which comprise natural or synthetic polyamides and especially natural or regenerated cellulose, such as cotton, filament viscose or staple viscose. The most preferred substrate is textile material comprising cotton.

As per another aspect of the present invention there is provided for the use of the above-defined compounds, their salts or mixtures for dyeing or printing the above-described substrates.

The compounds of the formula 1 can be used in dyeing liquors or in print pastes according to all dyeing or printing processes customary for reactive dyes. Preference is given to dyeing by the exhaust process in the temperature range of 40-70° C.

The compounds as per the invention can be used as individual dyes or, on account of their good compatibility, also as a combination element with other reactive dyes of the same class which possess comparable dyeing properties, such as for example their general fastnesses, their exhaustion and fixation yield, etc. The combination-shade dyeings obtained are as fast as the dyeings with the individual dye. Especially the dyes of the formula 1 are suitable as a blue trichromatic element.

The compounds of the formula 1 give good exhaustion and fixation yields. The unfixed dye portion is readily washed off. The dyeings and prints obtained exhibit good light fastness. They additionally exhibit good wet fastness properties for example with regard to washing, water, seawater and perspiration fastness and have good stability to oxidative influences such as to chlorinated water, hypochlorite bleach, peroxide bleach and also to perborate- and percarbonate-containing laundry detergents including especially those containing bleach activators, such as TAED etc.

As per a further aspect of the present invention there is provided a hydroxyl- or nitrogen-containing organic substrate which has been dyed or printed as per the above-described dyeing or printing process, including the jet printing process.

The present invention likewise provides subsumes, especially cellulose, polyamides and animal fibres, preferably cotton, that have been dyed with such compounds.

The invention likewise provides for the use of a compound of the formula (I) or mixtures thereof as a component in an ink jet printing ink. The invention further provides ink jet printing inks comprising mixtures according to the formula (I) or mixtures thereof. Such printing inks can be produced using various organic solvents and their mixtures, such as for example alcohols, ethers, esters, nitriles, carboxamides, cyclic amides, urea, sulphones and sulphone oxides.

Ink jet inks generally contain in total 0.5 to 35% by weight and preferably 1.5 to 15% by weight (reckoned dry) of one or more of the compounds according to the invention.

The process for producing the dye mixtures as per the formula 1 according to the invention comprises the following steps: The diazonium salt (4) is coupled under acid conditions onto 1-amino-8-hydroxynaphthalene-3,6-disulphonic acid (5) to form the monoazo dye (6a). The monoazo dye 6a then has the diazonium salt 7 coupled onto it under neutral conditions to form the dye 1a.

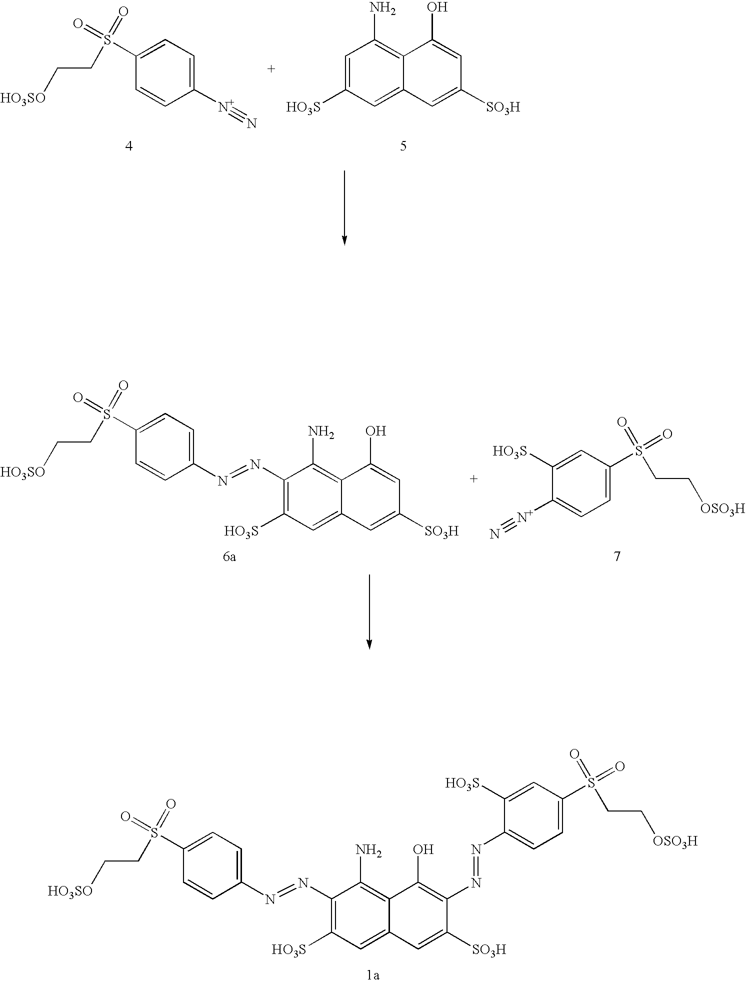

The compound (1a) is the bis-sulphatoethylsulphonyl reactive dye described in Example 1 of the patent specification CH 657 865 A5.

There are synthetic reasons why technical grades of the dye of the dye 1a will generally contain a 5-10% fraction of C.I. Reactive Black 5 (cf. formula 2a). Since the dye C.I. Reactive Black 5 has distinctly worse fastnesses than the dye 1a, the fraction of 2a (C.I. Reactive Black 5) should be minimized by suitable measures and it is for example advantageous in the synthesis of the dye of the formula 1a to keep the excess of the diazo component 4, which is customarily about 5-15% with regad to 1-amino-8-hydroxynaphthiaele-3,6-disulphonic acid (5), to a minimum.

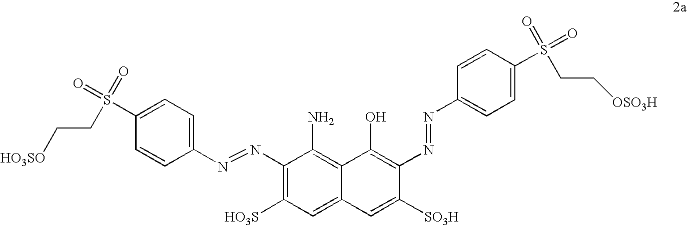

Treatment of the dye of the formula 1a with different amounts of a strong base such as an alkali metal hydroxide for example gives mixtures containing the dyes of the formulae 1a, 1b, 1c and 1d. The amount of base added is between 1.3 and 2.4 equivalents.

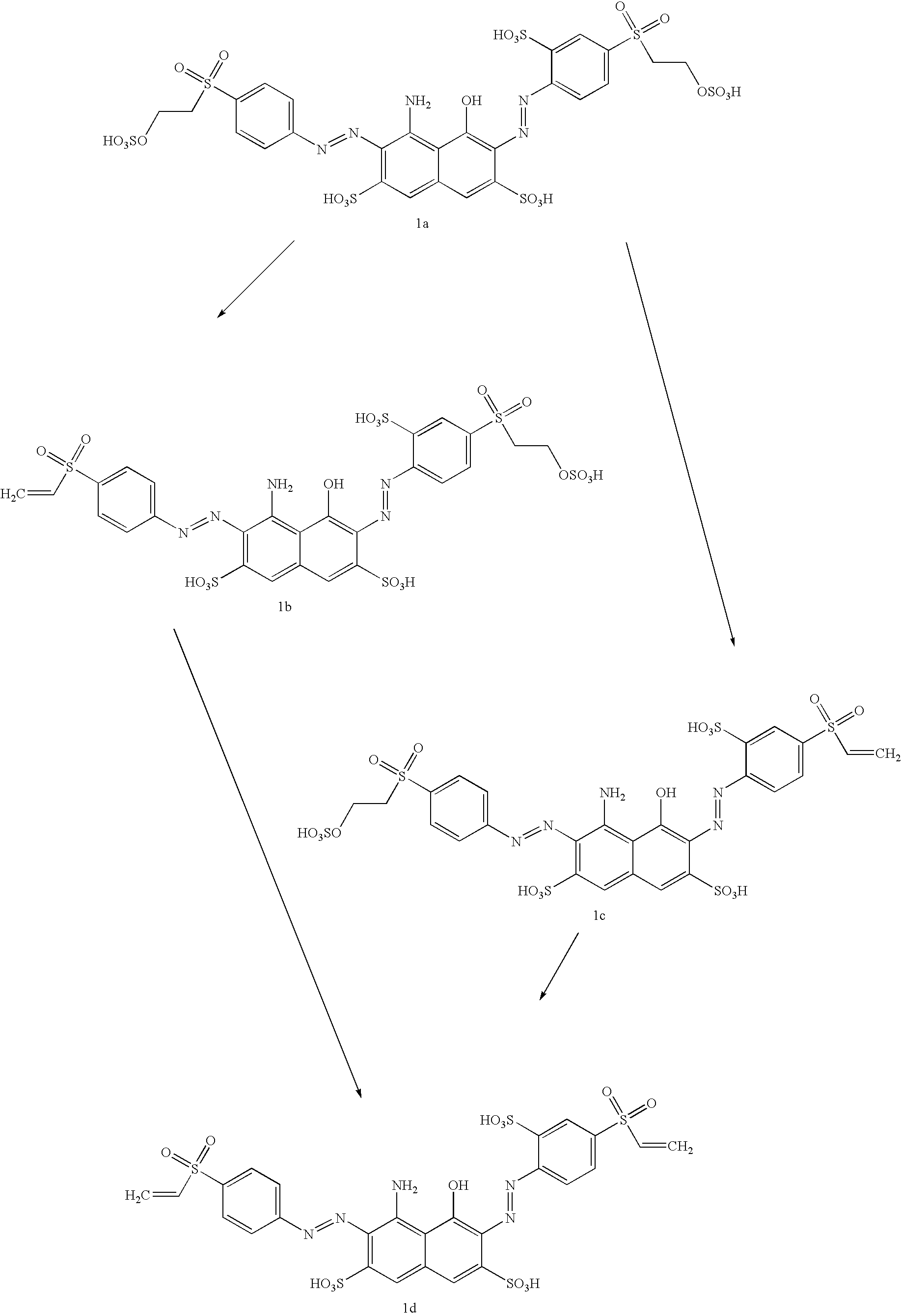

The mixtures produced by addition of 1.5-2 equivalents of a strong base such as sodium hydroxide contain the bis(vinyl sulphone) dye of the formula 1d as a main component. Such mixtures exhibit distinctly increased affinity over the original dye 1a in the salt phase of an exhaust dyeing process (prior to the addition of alkali in the dyeing process). In addition, these dye mixtures are very suitable for trichromatic dyeings with yellow/orange and red/brown elements. Despite the distinctly increased affinity, the dye mixtures according to the invention still exhibit good solubilities.

It will be appreciated that the dye 2a which may be present in the technical grade batches of the dye 1a will react with alkali in a similar manner to the dye 1a. An alkali treatment of the dye 2a gives rise to the dyes of the structures 2b, 2c and consequently to the dye of the structure 2d.

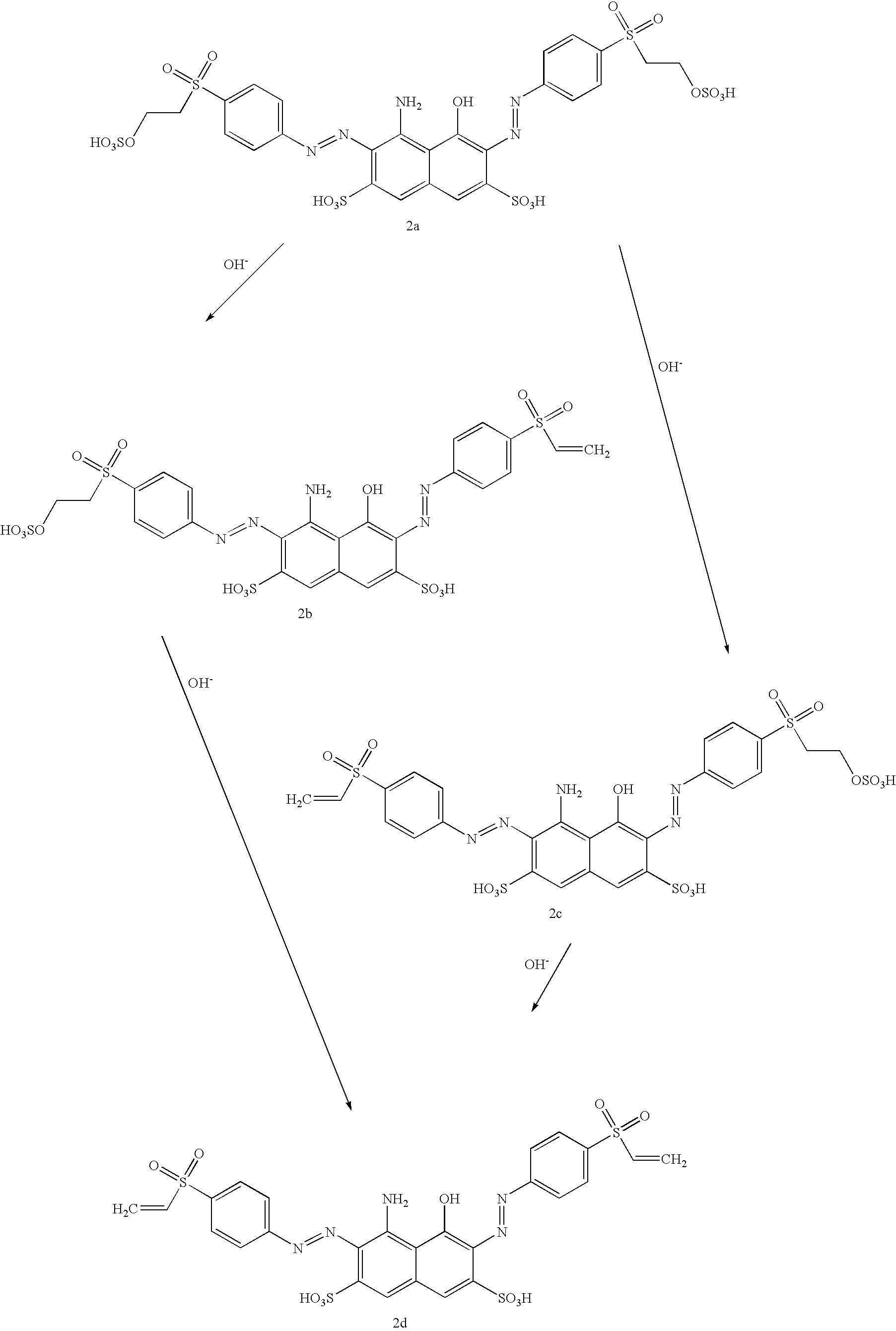

When 2-amino-5-(2′-sulphatoethylsulphonylbenzenesulphonic acid is prepared by sulphonation of 4-aminophenyl 2′-sulphatoethyl sulphone, as described in the patent specification DE 2538723, the dyes of the structures 3a and 3b will likewise be detectable in small amount in the reaction mixture.

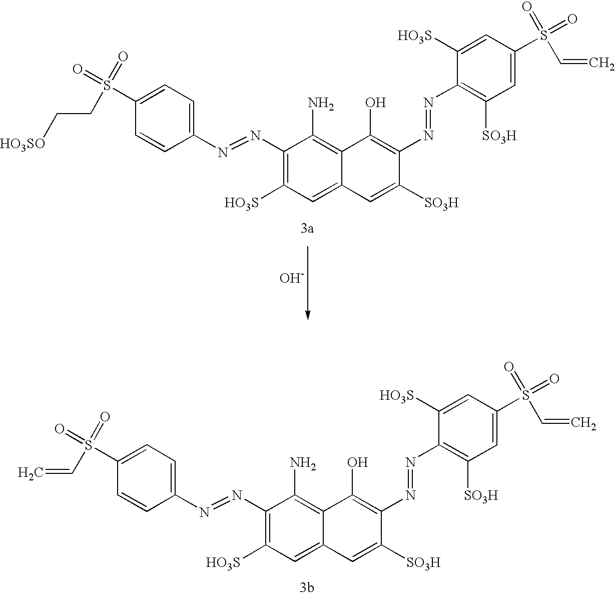

The dye 1d according to the invention or mixtures of the dyes 1a, 1b, 1c and 1d are suitable for use as blue components for the trichromatic dyeing process.

Various red, brown, yellow and orange dyes are suitable together with the blue component of the formula 1.

Preference is given to combinations containing compounds of the formula 1 or mixtures of compounds of the formula 1 and the fraction of the compound 1d in the mixtures as per formula 1 is more than 40% and at least one of the following compounds of the formula ria, rib, ric, rid, rii, riii, riv, rv, gi, gii, giii, giv or gv.

Preference for use as further components with the compounds of the formula 1 is given to red dyeing compounds of the formula ria 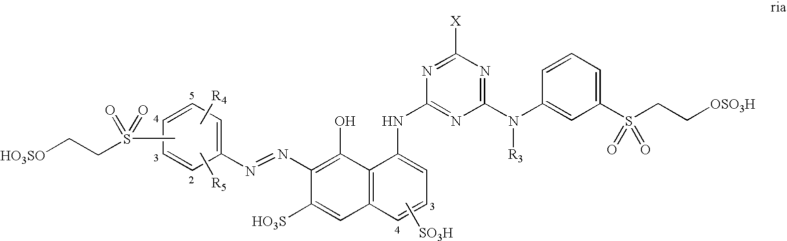
where
the SO₂ group is in position 3, 4 or 5;
R₃ is a proton, methyl or ethyl;
R₄ is a proton, a sulpho group or an alkoxy group;
R₅ is a proton, an allyl group or an alkoxy group; and
X is a halogen.

Preference for use as further components together with the compounds of the formula 1 is similarly given to mixtures of red dyes of the formula ria, rib, ric and rid 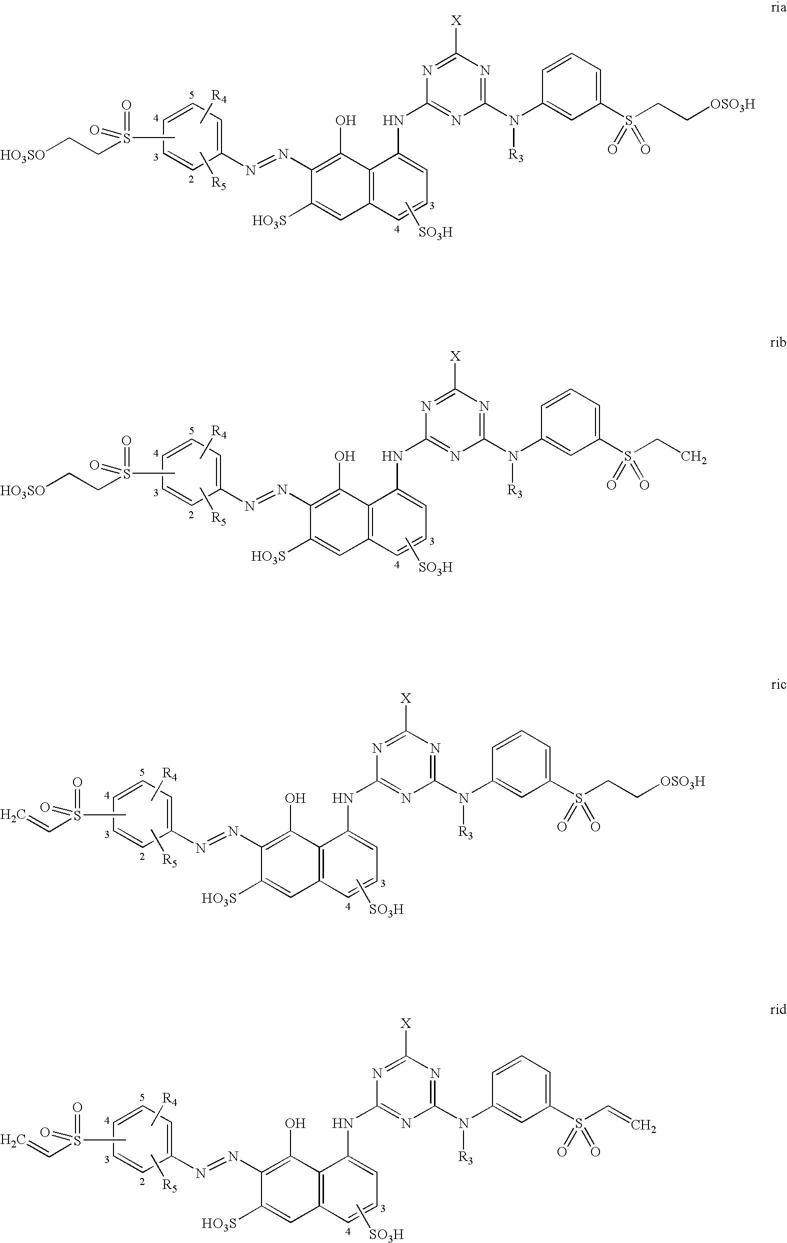
where the substituents are each as defined above.

Preference for use as further components together with the compounds of the formula 1 is similarly given to red dyeing compounds of the formula rii 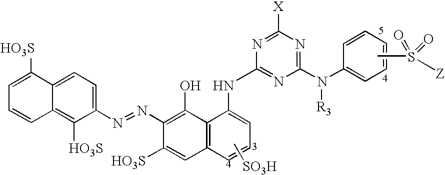
where the substituent R₃ is as defined above
and Z is CH₂CH₂Y or CH═CH₂
Y is an alkali-detachable group, such as —OSO₃H, Cl

Preference for use as further components together with the compounds of the formula 1 is similarly given to red dyeing compounds of the formula riii 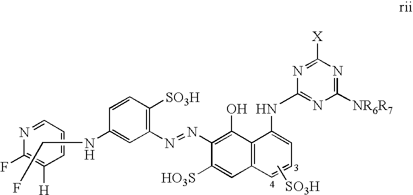
where
the SO₂H group is in position 3 or 4
—NR₆R₇ is morpholine or —NHCH₂CH₂OH and
X is a halogen.

Preference for use as further components together with the compounds of the formula 1 is similarly given to red dying compounds of the formula riv 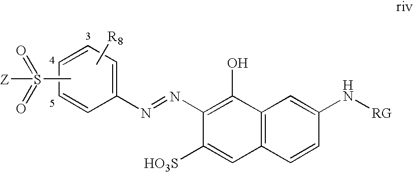
where
Z has the abovementioned meaning,
the SO₂ group is in position 3, 4 or 5;
R₈ is a proton, a sulpho group or an alkoxy group and
RG is a heterocyclic reactive group, such as a difluoropyrimidyl or monofluorotriazinyl group

Preference for use as further components together with the compounds of the formula 1 is similarly given to brown dyeing compounds of the formula rv 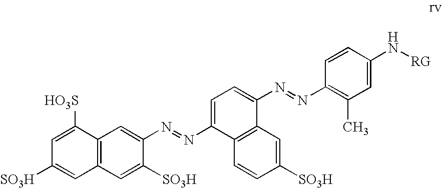
where RG has the abovementioned meaning

Preference for use as further components together with the compounds of the formula 1 is similarly given to yellow dyeing compounds of the formula gi 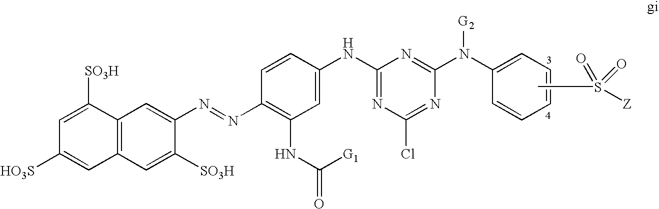
where Z has the abovementioned meaning
the SO₂ group is in position 3 or 4;
G₁ is NH₂ or CH₃,
G₂ is a proton, methyl or ethyl group;

Preference for use as further components together with the compounds of the formula 1 is similarly given to yellow dyeing compounds of the formula gii 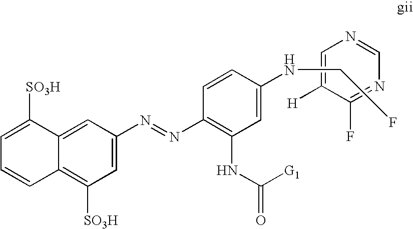
where G₁ has the abovementioned meaning

Preference for use as further components together with the compounds of the formula 1 is similarly given to orange dyeing compounds of the formula giii 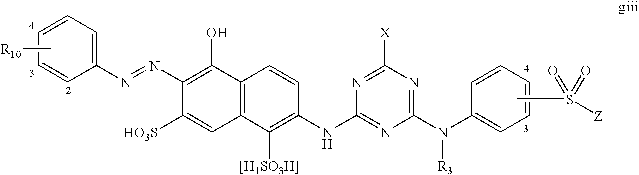
where
the substituents R₃ and Z have the abovementioned meanings,
the SO₂ group is in position 3 or 4;
R₁₀ is in position 2, 3 or 4 and is an SO₃H, COOH, or SO₂Z group,

Preference for use as further components together with the compounds of the formula 1 is similarly given to yellow or orange dyeing compounds of the formula giv 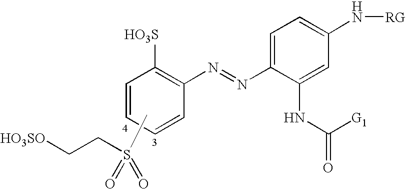
where G₁ and RG have the abovementioned meanings

Preference for use as further components together with the compounds of the formula 1 is similarly given to yellow dyeing compounds of the formula gv 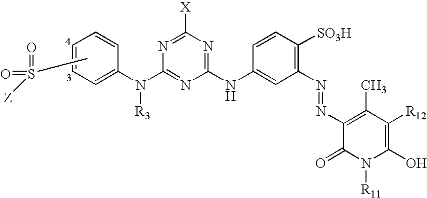
where X, R₃ and Z have the abovementioned meanings
R₁₁ is CH₃, C₂H₅ or CH₂CH₂COOH,
R₁₂ is a proton, CN, CONH₂, COOH or CH₂SO₃H

### EXAMPLES

### Example 1

A dye mixture prepared according to the synthesis in Example 1 of the patent specification CH 657 865 A5, of the following composition:

| | | |
|---|---|---|
| about 90 | parts | of the dye of the formula 1a, |
| about 5 | parts | of the dye of the formula 1b, |
| about 4 | parts | of the dye of the formula 1c and |
| about 1 | part | of the dye of the formula 1d, |

has the following composition following the addition of 1.5 equivalents of sodium hydroxide:

| | | |
|---|---|---|
| about 13 | parts | of the dye of the formula 1a, |
| about 13.5 | parts | of the dye of the formula 1b, |
| about 24.5 | parts | of the dye of the formula 1c and |
| about 36 | parts | of the dye of the formula 1d, |

where the formulae 1a, 1b, 1c, 1d have the abovementioned meaning

### Example 2

Reacting the dye mixture mentioned in Example 1 with 2 instead of 0.15 equivalents of sodium hydroxide affords a dye mixture of the following composition

| | | |
|---|---|---|
| about 0.5 | part | of the dye of the formula 1a, |
| about 2.5 | parts | of the dye of the formula 1b, |
| about 1.5 | parts | of the dye of the formula 1c and |
| about 77 | parts | of the dye of the formula 1d |

where the formulae 1a, 1b, 1c, 1d have the abovementioned meaning

### Example 3

4-Aminophenyl 2′-sulphatoethyl sulphone is sulphonated as described in DE 2538723. The sulphonation mixture is discharged onto ice, salted out and filtered off. 29.5 parts of 4-aminophenyl 2′-sulphatoethyl sulphone are diazotized and coupled under acid conditions onto 31.9 parts of 1-amino-8-hydroxynaphthalene-3,6-disulphonic acid.

99 parts of the abovementioned, about 40% strength salted-out filtered-off, acidic (due to sulphuric acid residues) sulphonation product (containing 39.7 parts of diazotizable amine) are diazotized and coupled at pH 5-7 onto the above-prepared reaction mixture of the acidic azo coupling of diazotized 4-aminophenyl 2′-sulphatoethyl sulphone onto 1-amino-8-hydroxynaphthaline-3,6-disulphonic acid.

This gives a reaction solution which contains the following dyes:

| | | |
|---|---|---|
| about 73 | parts | of the dye of the formula 1a, |
| 4 | parts | of the dye of the formula 1b, |
| about 3 | parts | of the dye of the formula 1c |
| about 10 | parts | of the dye of the formula 2a |
| about 1 | part | of the dye of the formula 1d |
| about 1 | part | of the dye of the formula 2b or 2c |
| about 5 | parts | of the dye of the formula 3a |

where the formulae 1a, 1b, 1c, 1d, 2a, 2b, 2c and 3a have the abovementioned meaning:

The reaction mixture is desalted by dialysis. The desalted reaction mixture is treated with 23.5 parts of concentrated sodium hydroxide solution at 15-25° C. for 2-3 h.

The reaction solution thus treated is a mixture which contains the following components:

| | | |
|---|---|---|
| about 0.5 | part | of the dye of the formula 1a, |
| about 2 | parts | of the dye of the formula 1b, |
| about 5 | parts | of the dye of the formula 1c |
| about 2 | parts | of the dye of the formula 2a |
| about 65 | parts | of the dye of the formula 1d |
| about 5 | parts | of the dye of the formula 2b or 2c |
| about 4 | parts | of the dye of the formula 3b, |

where the formulae 1a, 1b, 1c, 1d, 2a, 2b, 2c and 3b have the abovementioned meaning

The mixture obtained can be evaporated or directly used for dyeing.

Red and Brown Dyes

### Example r1

The condensation product of 63.8 parts of 1-amino-8-hydroxynaphthaline-4,6-disulphonic acid and 37 parts of 2,4,6-trichlorotriazine is reacted with 70 parts of 3-ethylamino-phenyl 2′-sulphatoethyl sulphone of the following formula r1b:

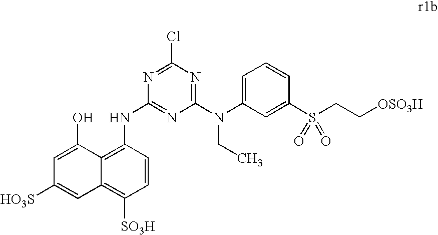

58 parts of 3-aminophenyl 2′-sulphatoethyl sulphone are diazotized and coupled at pH 5-5.5 onto the previously prepared coupling component r1b

The dye of the formula r1a 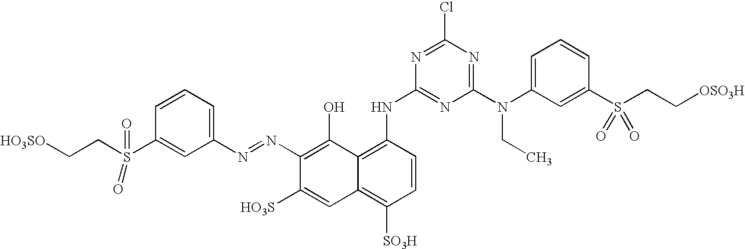
is salted out, filtered off and dried at 50° C., under reduced pressure

The following Examples r2-r18 are prepared similarly to Example r1a.

### Examples r2-r18

Examples r2-r18 of red dyeing compounds of the formula ria

| | |
|---|---|
| | ria |
| 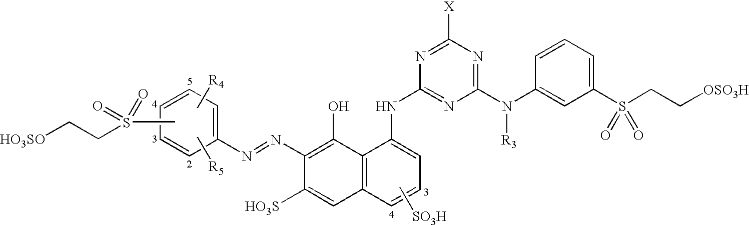 | |

| | —O₂S— | —SO₃H | | | | |
|---|---|---|---|---|---|---|
| Ex | position | position | R₃ | R₄ | R₅ | X |
| r2 | 3 | 3 | —CH₂CH₃ | H | H | F |
| r3 | 4 | 3 | —CH₂CH₃ | H | H | F |
| r4 | 4 | 3 | —CH₂CH₃ | H | H | Cl |
| r5 | 4 | 4 | —CH₂CH₃ | H | H | Cl |
| r6 | 4 | 4 | —CH₂CH₃ | H | H | F |
| r7 | 4 | 3 | —CH₃ | H | H | F |
| r8 | 3 | 3 | —CH₃ | H | H | F |
| r9 | 5 | 3 | —CH₂CH₃ | (2)-OCH₃ | H | Cl |
| r10 | 4 | 3 | —CH₂CH₃ | (2)-OCH₃ | (5)-CH₃ | Cl |
| r11 | 4 | 3 | —CH₃ | (2)-OCH₃ | (5)-OCH₃ | F |
| r12 | 4 | 4 | —CH₂CH₃ | (2)-OCH₃ | (5)-OCH₃ | Cl |
| r13 | 4 | 4 | —CH₂CH₃ | (2)-SO₃H | H | Cl |
| r14 | 5 | 3 | —CH₃ | (2)-SO₃H | H | F |
| r15 | 5 | 3 | —CH₂CH₃ | (2)-SO₃H | H | Cl |
| r16 | 4 | 3 | —CH₂CH₃ | (2)-SO₃H | H | Cl |
| r17 | 4 | 3 | —CH₂CH₃ | (2)-SO₃H | H | F |
| r18 | 3 | 3 | —CH₂CH₃ | (4)-OCH₃ | H | Cl |

Reacting dyes of the formula ri at room temperature with 1 equivalent of aqueous sodium hydroxide solution affords mixtures of red dyes of the formula (ria), (rib), (ric) and (rid).

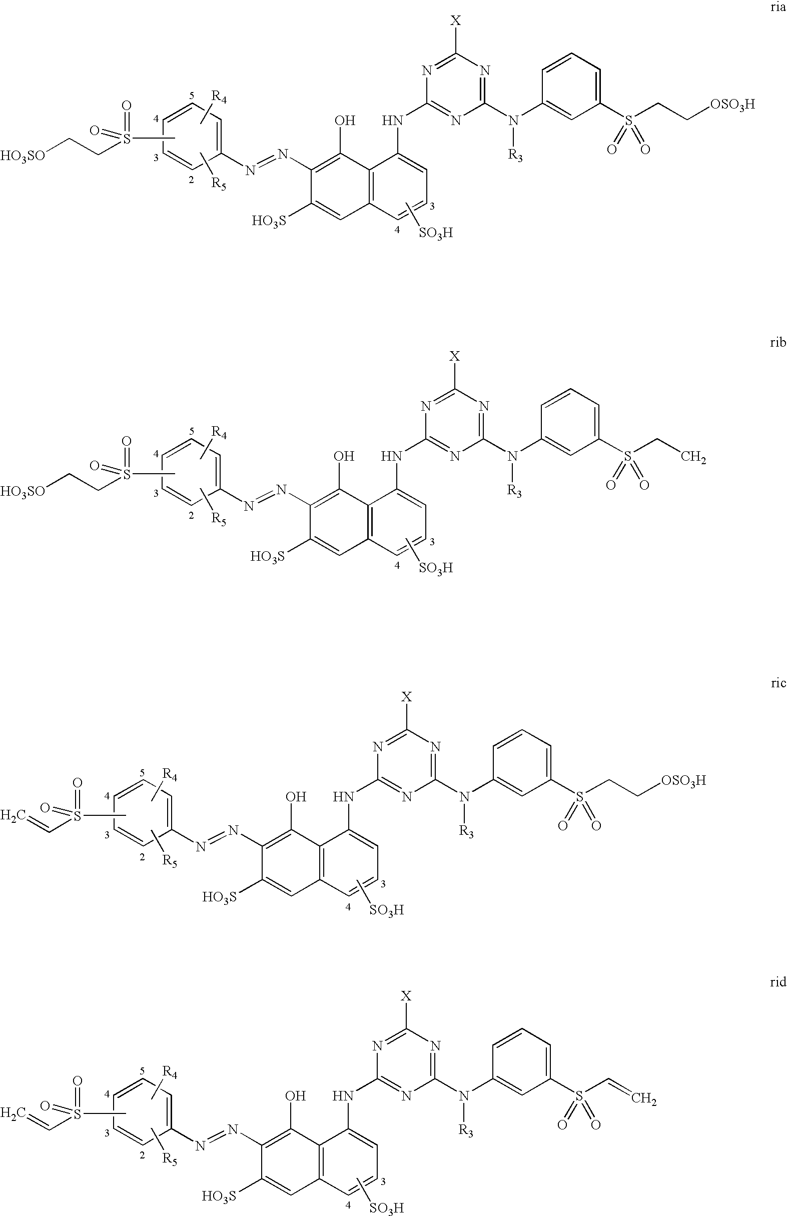

Example r19. Reacting a solution of the dye of the formula r1a with 1 equivalent of aqueous sodium hydroxide solution affords a dye mixture of the formulae r19a, r19b, r19c, r19d which is salted out, filtered off and dried at 50° C. under reduced pressure.

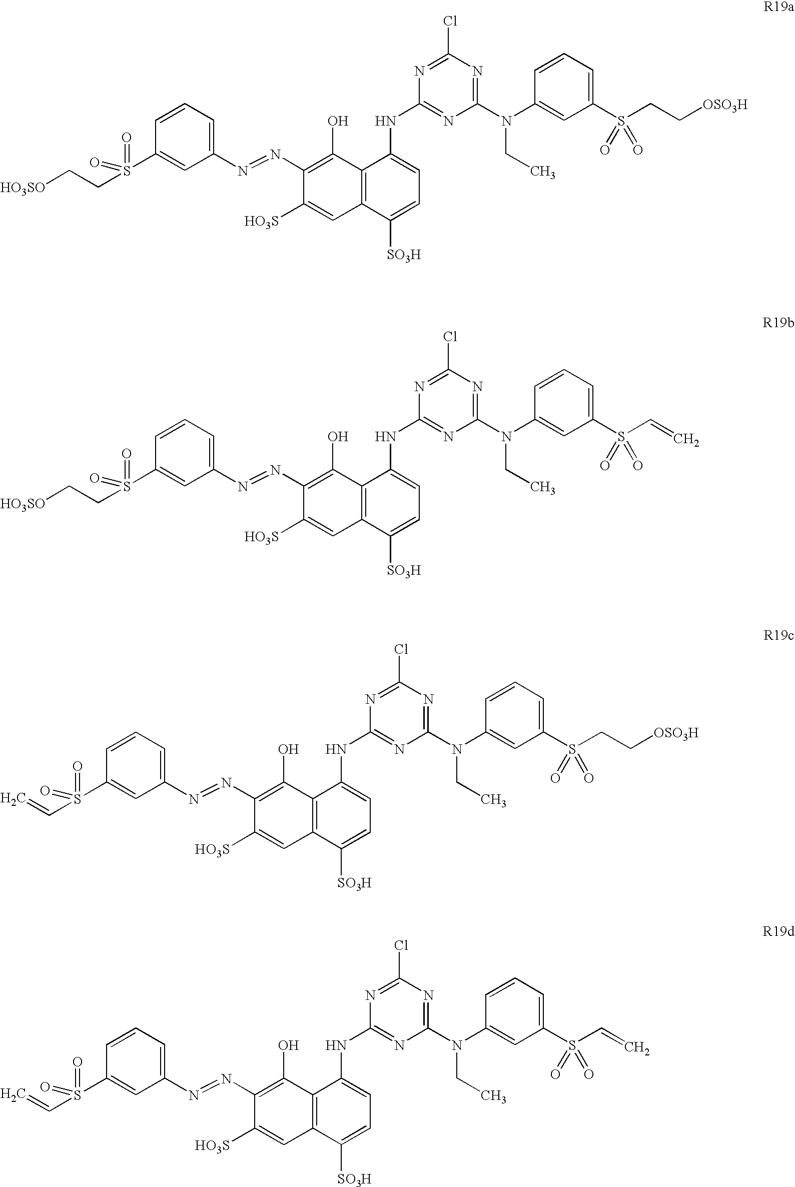

Examples r20-r35 can be prepared similarly to Example r19 by alkali treatment of Examples r2-r18 (compare formulae ria, rib, ric and rid).

| | —O₂S— | —SO₃H | | | | |
|---|---|---|---|---|---|---|
| Ex | position | position | R₃ | R₄ | R₅ | X |
| r20 | 3 | 3 | —CH₂CH₃ | H | H | F |
| r21 | 4 | 3 | —CH₂CH₃ | H | H | F |
| r22 | 4 | 3 | —CH₂CH₃ | H | H | Cl |
| r23 | 4 | 4 | —CH₂CH₃ | H | H | Cl |
| r24 | 4 | 4 | —CH₂CH₃ | H | H | F |
| r25 | 4 | 3 | —CH₃ | H | H | F |
| r26 | 3 | 3 | —CH₃ | H | H | F |
| r27 | 5 | 3 | —CH₂CH₃ | (2)-OCH₃ | H | Cl |
| r28 | 4 | 3 | —CH₂CH₃ | (2)-OCH₃ | (5)-CH₃ | Cl |
| r29 | 4 | 3 | —CH₃ | (2)-OCH₃ | (5)-OCH₃ | F |
| r30 | 4 | 4 | —CH₂CH₃ | (2)-OCH₃ | (5)-OCH₃ | Cl |
| r31 | 4 | 4 | —CH₂CH₃ | (2)-SO₃H | H | Cl |
| r32 | 5 | 3 | —CH₃ | (2)-SO₃H | H | F |
| r33 | 5 | 3 | —CH₂CH₃ | (2)-SO₃H | H | Cl |
| r34 | 4 | 3 | —CH₂CH₃ | (2)-SO₃H | H | Cl |
| r35 | 4 | 3 | —CH₂CH₃ | (2)-SO₃H | H | F |

### Example r36-r41

Examples r36-r41 can be prepared similarly to Example r1 by replacing 3-aminophenyl 2′-sulphatoethyl sulphone by 2-naphthylamine-1,5-disulphonic acid.

Examples of red dyeing compounds of the formula riia

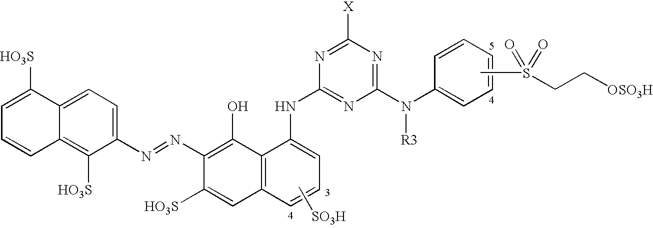

| | —O₂S— | —SO₃H | | |
|---|---|---|---|---|
| Ex | position | position | R₃ | X |
| r36 | 4 | 3 | —CH₂CH₃ | Cl |
| r37 | 4 | 3 | —CH₂CH₃ | Cl |
| r38 | 4 | 3 | H | Cl |
| r39 | 3 | 4 | —CH₂CH₃ | Cl |
| r40 | 3 | 3 | —CH₂CH₃ | Cl |
| r41 | 3 | 3 | H | Cl |

### Examples r42-r44

Examples of red dyeing compounds of the formula riii

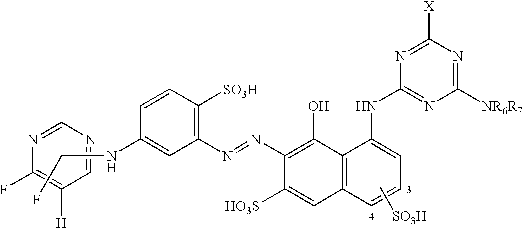

| | —SO₃H | | |
|---|---|---|---|
| Ex | position | —NR₆R₇ | X |
| r42 | 3 | 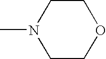 | F |
| r43 | 3 | 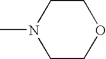 | Cl |
| r44 | 4 | —NHCH₂CH₂OH | Cl |

The dye r42 is described in EP525572. By changing the coupling component in the azo coupling reaction, the two examples r43 and r44 can be prepared similarly.

### Example r45

58 parts of 4-aminophenyl 2′-sulphatoethyl sulphone are diazotized and coupled at pH 6-7 onto the condensation product of 47.8 parts of 2-amino-8-hydroxynaphthaline-6-sulphonic acid and 28 parts of 2,4,6-trifluoropyrimidine. The dye conforming to formula R45 is salted out, filtered off and dried.

Examples of red dyeing compounds of the formula riva

| | |
|---|---|
| | riva |
| 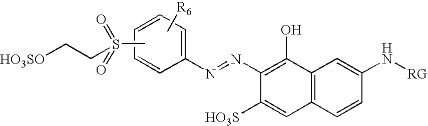 | |

| | —SO₂— | | |
|---|---|---|---|
| Ex | position | R₈ | RG |
| r45 | 4 | H | 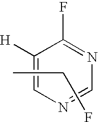 |

### Examples r46-r47

Examples of brown dyeing compounds of the formula rv

| | |
|---|---|
| | rv |
| 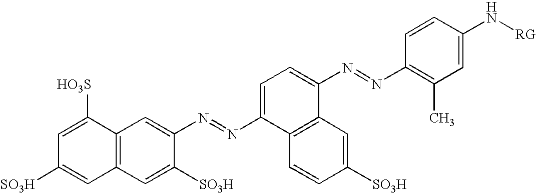 | |

| Ex | RG |
|---|---|
| r46 | 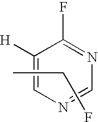 |
| r47 | 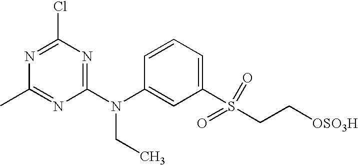 |

The brown dye r46 is prepared by condensation of 32 parts of 2,4,6-trifluoropyrimidine with 147 parts of the amino chromophore of the formula rva.

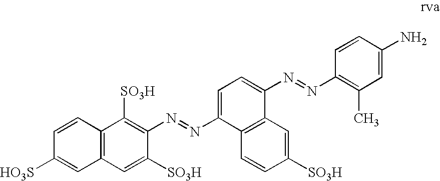

Replacing the 32 parts of 2,4,6-trifluoropyrimidine by 100 parts of a condensation product of 2,4,6-trichlorotriazine with 3-ethylaminophenyl 2′-sulphatoethyl sulphone affords the brown dye of the formula r47

Yellow or Orange Dyes

### Examples g1-g4

Examples of yellow dyeing compounds of the formula gia

| | |
|---|---|
| | gi |
| 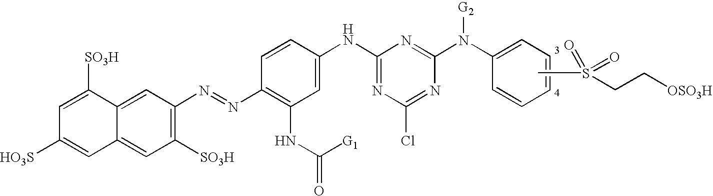 | |

| | —O₂S— | | |
|---|---|---|---|
| Ex | position | G₁ | G₂ |
| g1 | 4 | NH₂ | H |
| g2 | 3 | NH₂ | H |
| g3 | 4 | CH₃ | —CH₂CH₃ |
| g4 | 4 | CH₃ | H |

### Examples g5-g6

Examples of yellow dyeing compounds of the formula gii

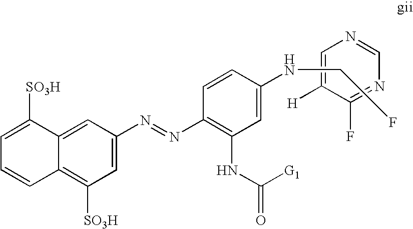

The dye of the formula g5 was described in Lehr, F. “Synthesis and application of reactive dyes with heterocyclic reactive systems” Dyes Pigm. (1990), 14(4), 239-63.

The dye of the formula g6 can be prepared in a similar manner.

| Ex | G1 |
|---|---|
| g5 | CH₃ |
| g6 | NH₂ |

### Examples g7-g11

Examples of orange dyeing compounds of the formula giiia. Examples g7-g11 can be prepared similarly to Example r1.

| | |
|---|---|
| | giiia |
| 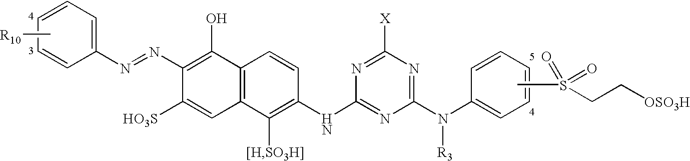 | |

| | | H, | | | |
|---|---|---|---|---|---|
| Ex. | R₁₀(Pos.) | SO₃H | R₃ | X | —SO2-pos |
| g7 | CH₂CH₂OSO₃H (4) | SO₃H | CH₂CH₃ | Cl | 3 |
| g8 | CH₂CH₂OSO₃H (4) | SO₃H | CH₂CH₃ | Cl | 4 |
| g9 | SO₃H (4) | H | H | Cl | 4 |
| g10 | SO₃H (4) | H | CH₂CH₃ | Cl | 3 |
| g11 | SO₃H (3) | H | H | Cl | 4 |

### Examples g12-g14

Examples of yellow or orange dyeing compounds of the formula giva

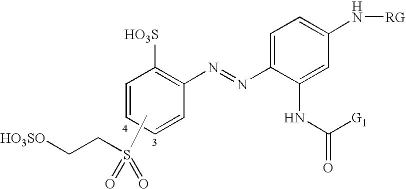

The preparation of Examples g12-g14 is evident from the German patent application DE 4425222 A1 or WO 9602593 A1

| | —SO₂CH₂CH₂OSO₃H | | |
|---|---|---|---|
| Ex. | position | G1 | RG′ |
| g12 | 4 | —NH₂ | 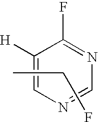 |
| g13 | 3 | —CH₃ | 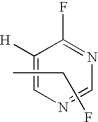 |
| g14 | 4 | —NH₂ | 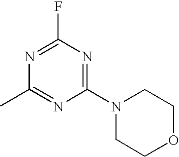 |

### Examples g15-g17

Examples of yellow dyeing compounds of the formula gva

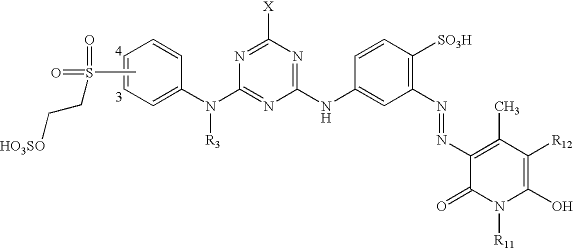

### Example g15

The condensation product of 58 parts of 3-aminophenyl 2′-sulphatoethyl sulphone and 37 parts of 2,4,6-trichlorotriazine is reacted with 38 parts of 2,4-diaminobenzenesulphonic acid. The intermediate formed is diazotized and coupled onto 38 parts of 1-ethyl-5-carbamoyl-6-hydroxy-4-methyl-2-pyridone. The resulting dye conforms to the formula g15

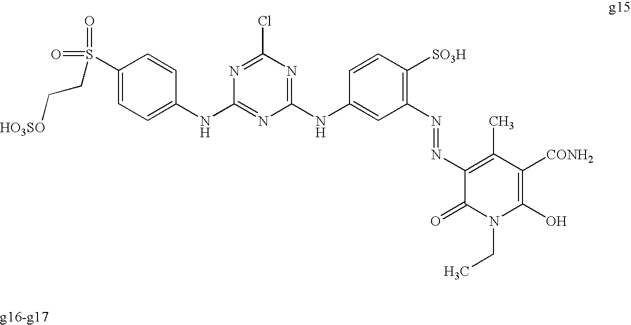

Examples g16 and g17 can be prepared in a similar fashion

| | —O₂S— | | | | |
|---|---|---|---|---|---|
| Ex | position | R₃ | R₁₁ | R₁₂ | X |
| g16 | 3 | —CH₂CH₃ | —CH₂CH₂COOH | —CONH₂ | Cl |
| g17 | 4 | H | —CH₂CH₂COOH | —CONH₂ | Cl |

Use Examples of Trichromatic Dyeings

A 20 g sample of a bleached cotton tricot is introduced at 60° C. into a solution of 16 g of sodium sulphate and

| | |
|---|---|
| 0.5% | (on weight of fibre) of the navy dye |
| | mixture as per Example 2 |
| 0.8% | of a yellow dye as per Example g2 |
| 0.5% | of a red dye as per Example r22 |

in 200 ml of water

At 60° C., portions of 0.3, 0.7 and 1 g of sodium carbonate are added after 30, 45 and 60 minutes respectively. The temperature is kept constant for a further 30 minutes. Thereafter, the dyed fabric is rinsed for 2 minutes with hot deionized water and for one minute in hot tap water. After boiling out in 1000 ml of deionized water for 20 minutes, the tricot is dried. The result is a brown cotton dyeing having excellent fastnesses.

### Use Examples 2-8

These examples are carried out similarly to Use Example 1, except for the use of the hereinbelow recited dye mixtures.

### Use Example Z (olive dyeing)

| | |
|---|---|
| 0.6% | of the navy dye mixture as per Example 3 |
| 0.4% | of a yellow dye as of Example g1 |
| 0.2% | of a red dye as of Example r38 |

### Use Example 3 (brown dyeing)

| | |
|---|---|
| 0.6% | of the navy dye mixture as per Example 2 |
| 0.9% | of an orange dye as of Example g9 |
| 0.3% | of a red dye as of Example r45 |

### Use Example 4 (olive dyeing)

| | |
|---|---|
| 0.6% | of the navy dye mixture as per Example 3 |
| 0.1% | of a yellow dye as of Example g5 |
| 0.1% | of a red dye as of Example r42 |

### Use Example 5 (brown dyeing)

| | |
|---|---|
| 0.3% | of the navy dye mixture as per Example 3 |
| 0.9% | of a yellow dye as of Example g2 |
| 0.5% | of a red dye as of Example r38 |

### Use Example 6 (olive dyeing)

| | |
|---|---|
| 0.3% | of the navy dye mixture as per Example 3 |
| 0.4% | of an orange dye as of Example g7 |
| 0.2% | of a red dye as of Example r38 |

### Use Example 7 (olive dyeing)

| | |
|---|---|
| 0.6% | of the navy dye mixture as per Example 2 |
| 0.4% | of a yellow dye as of Example g12 |
| 0.2% | of a red dye as of Example r22 |

### Use Example 8 (brown dyeing)

| | |
|---|---|
| 0.3% | of the navy dye mixture as per Example 3 |
| 0.9% | of a yellow dye as of Example g16 |
| 0.5% | of a red dye as of Example r38 |

1. A mixture containing at least one compound of formula 1 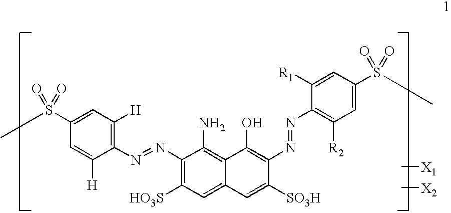
where
R₁ is H, or SO₃H,
R₂ is H, or SO₃H
X₁ is CH═CH₂, or CH₂CH₂OSO₃H
X₂ is CH═CH₂, or CH₂CH₂OSO₃H,
wherein the fraction of the compound 1d 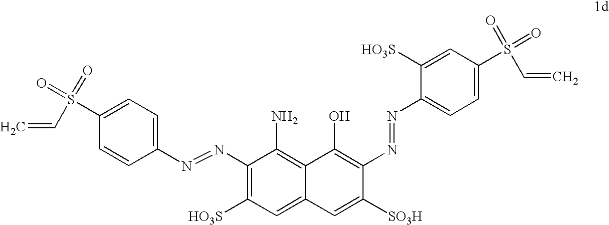
in the mixture is more than 40%:

2. The mixture of claim 1, wherein the at least one compound further comprises more than 50% of the compound of formula 1d 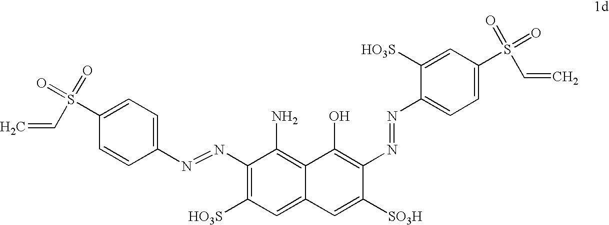
less than 20% of the compound of formula 2 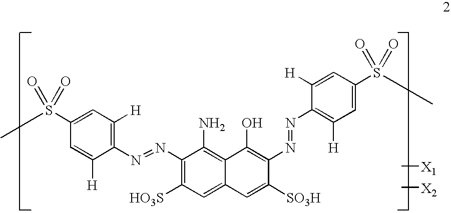
and less than 10% of the compound of formula 3 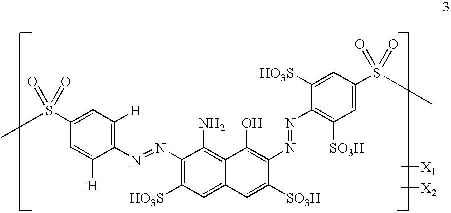
where
R₁ is H, or SO₃H,
R₂ is H, or SO₃H
X₁ is CH═CH₂, or CH₂CH₂OSO₃H
X₂ is CH═CH₂, or CH₂CH₂OSO₃H.

3. A blue dye component for a trichromatic dyeing process comprising a mixture as claimed in claim 1.

4. An ink jet printing ink comprising a mixture according to claim 1.

5. A process for printing or dyeing a hydroxyl- or nitrogen-containing organic substrate comprising the step of contacting the substrate with a mixture according to claim 1.

6. A hydroxyl- or nitrogen-containing organic substrate made in accordance with the process of claim 5.

7. A blue dye component for a trichromatic dyeing process comprising a mixture as claimed in claim 6.

8. An ink jet printing ink comprising a mixture according to claim 2.

9. A process for printing or dyeing a hydroxyl- or nitrogen-containing organic substrate comprising the step of contacting the substrate with a mixture according to claim 2.

10. A hydroxyl- or nitrogen-containing organic substrate made in accordance with the process of claim 9.
